(19) United States
(12) Patent Application Publication
(10) Pub. No.: US 2009/0039563 A1
(43) Pub. Date: Feb. 12, 2009

(54) METHOD OF FORMING FINE PATTERN

(75) Inventors: Motoki Okinaka, Saitama (JP); Kazuhito Tsukagoshi, Saitama (JP); Yoshinobu Aoyagi, Saitama (JP)

Correspondence Address: Muncy, Geissler, Olds & Lowe, PLLC, P.O. BOX 1364, FAIRFAX, VA, 22038-1364, US

(73) Assignee: RIKEN, Saitama (JP)

(21) Appl. No.: 12/065,246

(22) PCT Filed: Aug. 25, 2006
(86) PCT No.: PCT/JP2006/316682

§ 371 Date: Aug. 22, 2008

(30) Foreign Application Priority Data
Aug. 30, 2005 (JP) 2005-249447

(51) Int. Cl. B29C 59/16

(52) U.S. Cl. 264/446

(57) ABSTRACT

A method of fine-pattern formation in which in forming a pattern, a fine pattern formed in a mold can be transferred to a pattering material in a short time at a low temperature and low pressure and, after the transfer of the fine pattern to the patterning material, the fine pattern formed in the patterning material does not readily deform. The method for fine-pattern formation comprises: a first step in which a mold having a fine structure with recesses/protrusions is pressed against a pattering material comprising a polysilane; a second step in which the patterning material is irradiated with ultraviolet to photooxidize the patterning material; a third in which the pressing of the mold against the patterning material is relieved and the mold is drawn from the pattering material; and a fourth step in which that surface of the patterning material to which the fine pattern has been transferred is irradiated with an oxygen plasma to oxidize the surface.

### TECHNICAL FIELD

The present invention relates to a method of forming a fine pattern, and more particularly to a method of forming a fine pattern for forming the fine pattern having a fine structure with recesses/protrusions of nm order on a patterning material.

### BACKGROUND ART

Heretofore, a nanoimprint technology has been known as a method for forming a fine pattern having a fine structure with recesses/protrusions of nm order.

In this connection, a technique of lithography in which a nanoimprint technology is applied has been heretofore used. The technique concerns a method which is conducted as shown in, for example, FIGS. 1(a), 1(b), and 1(c) in such that a mold 100 (the mold may be made from, for example, a Si substrate.) on which a fine pattern having a fine structure with recesses/protrusions of nm order is formed, and a substrate 104 such as a Si substrate on which a patterning material 102 made from a resin material such as PMMA being an organic material to be used for the patterning material is applied are prepared (the setup: FIG. 1(a)); the mold 100 is then pressed against the patterning material 102 at a temperature of around 100 to 200° C. and a pressure of around 1 to 10 MPa (the pressing: FIG. 1(b)); and the mold 100 is drawn from the patterning material 102 after the lapse of a predetermined period of time (the release: FIG. 1(c)), whereby the fine pattern having the fine structure with recesses/protrusions of nm order formed on the mold 100 is transferred to the patterning material 102 to complete the patterning.

It is to be noted that FIG. 1(d) is an explanatory view showing a condition wherein the fine pattern having the fine structure with recesses/protrusions of nm order formed on the mold 100 is observed by a scanning electron microscope; and FIG. 1(e) is an explanatory view showing a condition wherein the fine pattern transferred to the patterning material 102 is observed by a scanning electron microscope.

When a lithography method which uses such nanoimprint lithographic technology is compared with a photolithographic technology which serves as the backbone of the existing semiconductor technology, the former technology is very excellent in the following points.

(1) The principle thereof is simple, and the processes therefor are speedy.

(2) A wet process using an organic solvent is not required, so that the process is environmentally-friendly.

(3) The former technology can be implemented by extremely inexpensive equipment (for example, around ten million to one hundred million yen) as compared with the very expensive stepper (for example, around several thousand million yen) used in photolithography technology.

According to the information obtained by the present inventor(s), the minimum size of patterning is 5 nm reported as of now.

As described above, the nanoimprint technology is an excellent technology by which a working operation in nm order, for example, the minimum size of 5 nm can be conducted in a very short time. In such a nanoimprint technology, a patterning material made from an organic material through which a fine pattern is easily transferred has been usually applied. Namely, the patterning material made from an organic material has a low melting point and is flexible, so that it is softened at a comparatively low temperature of 60 to 150° C., whereby the fine pattern formed on a mold can be easily transferred.

However, it has been pointed out that a conventional patterning material made from an organic material such as PMMA involves such problems that the patterning material absorbs easily moisture, that it exhibits a weak resistance to chemicals, that it has a poor thermal resistance, i.e., when a temperature is raised, the fine pattern transferred deforms easily, and that it has a comparatively low hardness; consequently, the use conditions thereof are inevitably restricted.

Under the circumstances, such a technique that a patterning material made from an inorganic material is used in place of a conventional patterning material made from an organic material such as PMMA is proposed in recent years. The patterning material made from an inorganic material exhibits remarkably distinguished characteristic features as to water absorption property, chemical resistance, heat resistance, and hardness in comparison with a conventional patterning material made from an organic material such as PMMA.

However, an inorganic material has a high melting point so that it is hard at normal temperatures, consequently there is such problem that a further requirement is added as to pattern formation wherein a mold is pressed against a patterning material to transfer a fine pattern of the mold to the patterning material, and this process must be conducted at a high temperature and high pressure, besides the processing time therefor is prolonged. It is to be noted that such high temperature and high pressure conditions as described above are, for example, a temperature of around 200 to 590° C. and a pressure of around 22 to 100 MPa, and further, a processing time therefor is around 60 seconds to 40 minutes.

According to the nanoimprint technique wherein the patterning material made from an inorganic material is used as described above, since the processing therefor must be conducted under the conditions of a high temperature and high pressure, the load becomes significant with respect to the nanoimprint equipment and the mold. As a consequence, it results in further problems of a fear of damaging and troubling the equipment and mold as well as of taking much time for processing such nanoimprint technique.

Furthermore, there is such a problem that since the technique takes the high-temperature process as described above in the nanoimprint technique wherein a patterning material made from an inorganic material is used, the fine pattern formed on the patterning material expands and shrinks due to thermal fluctuation, so that the fine pattern formed on the patterning material is easily deformed.

Moreover, there is also such a problem that the achievement of a high aspect ratio structure is difficult in a conventional manner wherein the above-described conventional inorganic materials are used for the patterning material, because of the variety of problems as described above.

### DISCLOSURE OF THE INVENTION

### Problems to be Solved by the Invention

The present invention has been made in view of the variety of the problems as described above involved in the prior art, and an object of the invention is to provide a method of forming a fine pattern by which it becomes possible to transfer a fine pattern formed on a mold to a patterning material at a low temperature and low pressure for a short period of time in the case of pattern formation wherein the mold is pressed against the patterning material to transfer the fine pattern of the mold to the patterning material; and after the fine pattern of the mold is transferred to the patterning material, the patterning material exhibits excellent properties as to water absorption, chemical resistance, heat resistance, and hardness; besides the fine pattern formed on the patterning material is not easily deformed.

Furthermore, another object of the invention is to provide a method of forming a fine pattern by which a high aspect ratio structure can be realized.

### Means for Solving the Problems

In order to achieve the above-described object, the invention is constituted in such that polysilane is used for a patterning material, whereby it becomes possible to transfer a fine pattern formed on a mold to the patterning material at low temperature and low pressure for a short period of time, and further the patterning material is vitrified after the fine pattern of the mold is transferred to the patterning material. Consequently, the patterning material exhibits excellent properties as to water absorption, chemical resistance, heat resistance, and hardness, so that the fine pattern formed on the patterning material is not easily deformed.

Thus, according to the invention, a fine pattern formed on a mold can be transferred to a patterning material at a low temperature and pressure as in the case that an organic material such as a conventional PMMA is used for a patterning material; and further after the fine pattern of the mold is transferred to the patterning material, the patterning material exhibits excellent properties as to water absorption, chemical resistance, heat resistance, and hardness as in the case that an inorganic material is used for the patterning material, so that there is not such a fear that the fine pattern formed on the patterning material is easily deformed.

Moreover, according to the invention, the transfer of a fine pattern to a patterning material is easy, and the fine pattern transferred to the patterning material is not easily deformed, so that it becomes possible to achieve a high aspect ratio structure.

It is to be noted that polysilane is a high molecular compound in which the backbone chain is composed of only silicon atoms wherein Si—Si bond changes into Si—O—Si bond as a result of irradiation with ultraviolet.

Namely, according to the invention, a method of forming a fine pattern by pressing a mold, on which a fine pattern having a fine structure with recesses and protrusions has been formed, against a patterning material to transfer the fine pattern having the fine structure with recesses and protrusions to the patterning material, which may comprise a first step for pressing the mold, on which the fine pattern having the fine structure with recesses and protrusions has been formed, against a patterning material made from polysilane; a second step for irradiating the patterning material with ultraviolet while maintaining the condition in which the mold is pressed against the patterning material to photooxidize the patterning material; a third step for releasing the pressing of the mold against the patterning material to draw the patterning material from the mold; and a fourth step for irradiating the surface of the patterning material to which the fine pattern of the patterning material, which was drawn from the mold in the third step, has been transferred with oxygen plasma to oxidize the surface of the patterning material to which the fine pattern of the patterning material has been transferred.

According to the above-described invention, the method may comprise further a fifth step for heating the patterning material which was irradiated with oxygen plasma in the fourth step.

According to the above-described invention, the method may comprise further a step for heating the polysilane prior to applying the first step.

According to the above-described invention, in the method, the mold may be made from a material through which ultraviolet transmits; and the irradiation with ultraviolet in the second step may be implemented in such that the patterning material is irradiated with ultraviolet from the side of the mold.

According to the above-described invention, in the method, the patterning material may be disposed on the substrate; the substrate may be made from a material through which ultraviolet transmits; and the irradiation with ultraviolet in the second step may be implemented in such that the patterning material is irradiated with ultraviolet from the side of the substrate.

According to the above-described invention, in the method, the material through which ultraviolet transmits may be quartz glass.

According to the above-described invention, a method of forming a fine pattern by pressing a mold, on which a fine pattern having a fine structure with recesses and protrusions has been formed, against a patterning material to transfer the fine pattern having the fine structure with recesses and protrusions to the patterning material, which may comprise a first step for pressing the mold, on which the fine pattern having the fine structure with recesses and protrusions has been formed, against a patterning material made from polysilane; a second step for irradiating the patterning material with ultraviolet while maintaining the condition in which the mold is pressed against the patterning material to photooxidize a region of the patterning material except for the boundary face region between the patterning material and the mold; a third step for releasing the pressing of the mold against the patterning material to draw the patterning material from the mold; a fourth step for irradiating the surface of the patterning material to which the fine pattern of the patterning material, which was drawn from the mold in the third step, has been transferred with oxygen plasma to oxidize the surface of the patterning material to which the fine pattern of the patterning material has been transferred; and a fifth step for irradiating the patterning material with ultraviolet to photooxidize the boundary face region which has not yet been photooxidized in the second step.

According to the above-described invention, the method may comprise further a sixth step for heating the patterning material which was irradiated with ultraviolet in the fifth step.

According to the above-described invention, the method may comprise further a step for heating the polysilane prior to applying the first step.

According to the above-described invention, in the method, the patterning material may be disposed on the substrate; the substrate may be made from a material through which ultraviolet transmits; and the irradiation with ultraviolet in the second step may be implemented in such that the patterning material is irradiated with ultraviolet from the side of the substrate.

According to the above-described invention, in the method, the material through which ultraviolet transmits may be quartz glass.

According to the above-described invention, in the method, the patterning material may be polymethyl phenylsilane (PMPS).

### ADVANTAGEOUS EFFECTS OF THE INVENTION

Since the invention is constituted as described above, it results in such excellent advantageous effects that it becomes possible to transfer a fine pattern formed on a mold to a patterning material at a low temperature and low pressure for a short period of time in case of the imprinting process wherein the mold is pressed against the patterning material to transfer the fine patter of the mold to the patterning material; and that after the fine pattern of the mold is transferred to the patterning material, the patterning material is vitrified so that it exhibits excellent properties as to water absorption, chemical resistance, heat resistance, and hardness; besides that the fine pattern formed on the patterning material is not easily deformed.

Furthermore, since the invention is constituted as described above, it results in such excellent advantageous effect that a high aspect ratio structure which has never been attained in the prior art can be realized.

### BRIEF DESCRIPTION OF THE DRAWINGS

FIGS. 1(a), 1(b), 1(c), 1(d), and 1(e) are explanatory views showing a conventional nanoimprint lithographic technique wherein FIG. 1(a) illustrates a setup step, FIG. 1(b) illustrates a pressing step, FIG. 1(c) illustrates a releasing step, FIG. 1(d) is an explanatory view showing a condition wherein the fine pattern of nm order formed on a mold is observed by a scanning electron microscope, and FIG. 1(e) is an explanatory view showing a condition wherein the fine pattern transferred to a patterning material is observed by a scanning electron microscope.

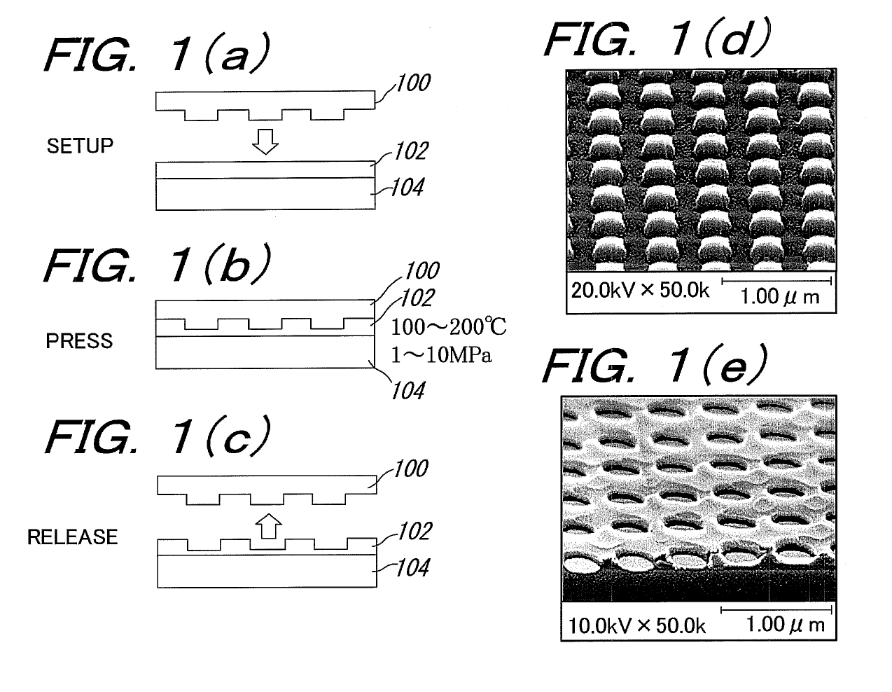

FIG. 2 is a conceptual, constitutional, explanatory view showing an example of the nanoimprint apparatus used in case of conducting the method of forming a fine pattern according to a first embodiment of the invention.

FIG. 3 is a flowchart showing steps for the processing procedure of the method of forming a fine pattern according to the first embodiment of the invention.

FIGS. 4(a), 4(b), 4(c) and 4(d) are conceptual explanatory views showing respective steps in the processing procedure of the method of forming a fine pattern according to the first embodiment of the invention wherein FIG. 4(a) shows a first step of a prebaking treatment step, FIG. 4(b) shows a second step of a pressing treatment step, FIG. 4(c) shows a third step of an ultraviolet irradiating treatment step, and FIG. 4(d) shows a fourth step of a releasing treatment step.

FIGS. 5(a) and 5(b) are conceptual explanatory views showing respective steps in the processing procedure of the method of forming a fine pattern according to an example of the first embodiment of the invention wherein FIG. 5(a) shows a fifth step of an oxygen plasma irradiating treatment step, and FIG. 5(b) shows a sixth step of a post-baking treatment step.

FIG. 6 is a graph showing the experimental results as to the height ratio dependency of temperatures of postbake made by the inventor(s) of the present application wherein the abscissa indicates bake temperatures of post-baking and the ordinate indicates height ratios.

FIG. 7 is a graph showing the experimental results of pressing a mold against a patterning material made by the inventor(s) of the present application wherein the abscissa indicates temperatures (imprint temperatures) in case of the pressing and the ordinate indicates height ratios.

FIG. 8 is a graph showing the experimental results as to ultraviolet transmission made by the inventor(s) of the present application wherein the abscissa indicates wavelengths and the ordinate indicates transmittances.

FIG. 9 is an explanatory view showing a condition wherein the fine pattern transferred to a pattering material by means of the processing procedures of the method of forming a fine pattern according to the first embodiment of the invention is observed by a scanning electron microscope.

FIG. 10 is an explanatory view showing a condition wherein the fine pattern transferred to a pattering material by means of the processing procedures of the method of forming a fine pattern according to the first embodiment of the invention is observed by a scanning electron microscope.

FIG. 11 is an explanatory view for explaining a condition in the photooxidation of polysilane being a patterning material as a result of irradiation with ultraviolet by means of the method of forming a fine pattern according to the invention.

FIG. 12 is a conceptual, constitutional, explanatory view showing an example of the nanoimprint apparatus used in case of conducting the method of forming a fine pattern according to a second embodiment of the invention.

FIG. 13 is a flowchart showing steps for the processing procedure of the method of forming a fine pattern according to the second embodiment of the invention.

FIGS. 14(a), 14(b), 14(c) and 14(d) are conceptual explanatory views showing respective steps in the processing procedure of the method of forming a fine pattern according to the second embodiment of the invention wherein FIG. 14(a) shows a third step of a first ultraviolet irradiating treatment step, FIG. 14(b) shows a fourth step of a releasing step, FIG. 14(c) shows a fifth step of an oxygen plasma irradiating treatment step, and FIG. 14(d) shows a sixth step of a second ultraviolet irradiating treatment step.

FIGS. 15(a) and 15(b) are explanatory views for explaining the condition in photooxidation of polysilane being a patterning material as a result of irradiation with ultraviolet in the method of forming a fine pattern according to the invention.

FIG. 16 is an explanatory view for explaining the method of forming a fine pattern according to the second embodiment of the invention.

FIGS. 17(a) and 17(b) are graphs each showing the experimental results as to changes in chemical resistance made by the inventor(s) of the application in which the abscissa indicates cleaning periods of time and the ordinate indicates height ratios wherein FIG. 17(a) shows the experimental results with respect to the samples patterned in accordance with the first embodiment, while FIG. 17(b) shows the experimental results with respect to the samples patterned in accordance with the second embodiment.

FIG. 18 is an explanatory view showing a condition wherein the fine pattern transferred to a patterning material by means of the processing procedures for the method of forming a fine pattern according to the second embodiment of the invention is observed by a scanning electron microscope.

FIG. 19(a) is an explanatory view showing a condition wherein the fine pattern of nm order formed on a mold is observed by a scanning electron microscope, and FIG. 19(b) is an explanatory view showing a condition wherein the fine pattern transferred to a patterning material by means of the method of forming a fine pattern according to the second embodiment of the invention is observed by a scanning electron microscope.

FIG. 20(a) is an explanatory view showing a condition wherein the fine pattern of nm order formed on a mold is observed by a scanning electron microscope, and FIG. 20(b) is an explanatory view showing a condition wherein the fine pattern transferred to a patterning material by means of the method of forming a fine pattern according to the second embodiment of the invention is observed by a scanning electron microscope.

FIG. 21(a) is a graph showing the experimental results for determining a relationship between bake temperatures and Vickers hardnesses in the post-baking treatment made by the inventor(s) of the application, and FIG. 21(b) is a graph showing the measured results of a FT-IR measurement made by the inventor(s) of the application.

### EXPLANATION OF REFERENCE NUMERALS

10 nanoimprint apparatus
10′ nanoimprint apparatus
12 sample holder
12a heater
14 stepping motor
16 superhigh pressure mercury lamp
16′ superhigh pressure mercury lamp
200 mold
202 patterning material
202a surface of patterning material
204 substrate

### THE BEST MODE FOR EMBODYING THE INVENTION

In the following, an example of embodiments of the method of forming a fine pattern according to the present invention will be described in detail by referring to the accompanying drawings.

### First Embodiment

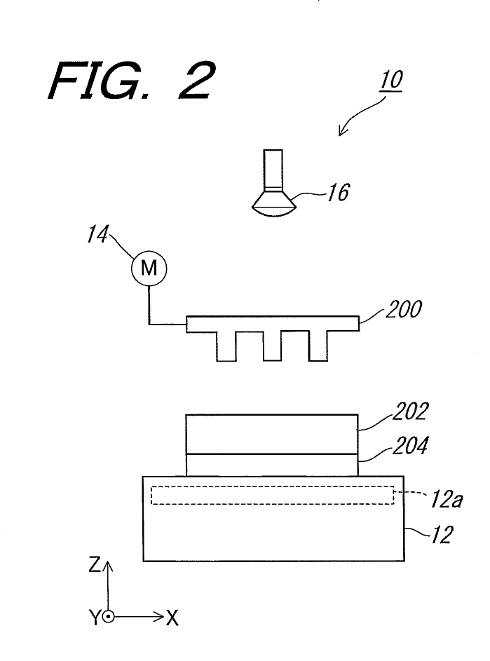

First, the first embodiment of the method of forming a fine pattern according to the invention will be described. In the case that the first embodiment of the method of forming a fine pattern according to the invention is conducted, for example, a nanoimprint apparatus 10 as shown in FIG. 2 is used for pressing a mold against a patterning material.

First, the nanoimprint apparatus 10 will be described. The nanoimprint apparatus 10 is provided with a sample holder 12 and adapted to be capable of placing a substrate 204 on the surface of the sample holder 12 wherein a patterning material 202 made from polysilane has been formed on the upper surface of substrate 204. A heater 12a is housed in the sample holder 12.

On one hand, a mold 200 on the under surface of which a fine structure with recesses/protrusions is formed is provided with a stepping motor 14 by which the mold 200 is driven movably along Y-Z directions.

Moreover, a superhigh pressure mercury lamp 16 for implementing ultraviolet irradiation with respect to the patterning material 202 is placed over the mold 200.

In the nanoimprint apparatus 10, the mold 200 is made from quartz glass through which the ultraviolet irradiated from the superhigh pressure mercury lamp 16 transmits. Consequently, the ultraviolet irradiated from the superhigh mercury lamp 16 transmits the mold 200 made of quartz glass, then the patterning material 200.

In the case that a nanoimprint operation for transferring the fine pattern formed on the mold 200 to the patterning material 202 is conducted by using the above-described nanoimprint apparatus 10 in accordance with the method of forming a fine pattern of the invention, first, the substrate 204 on which the patterning material 202 has been formed is placed on the sample holder 12 of the nanoimprint apparatus 10 as shown in FIG. 2.

In the method of fine-pattern formation of the invention, polymethyl phenylsilane (PMPS) being a polysilane is used for the patterning material 202.

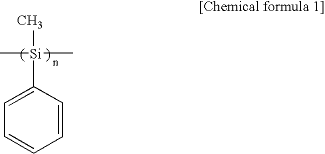

In order to form polymethyl phenylsilane serving as the patterning material 202 on the surface of the substrate 204, for example, a spin-coating treatment may be applied.

Polysilane means collectively high molecular compounds in which the backbone chain is composed of only silicon atoms, and a variety of functional groups are combined with the side chains thereof. The above-described polymethyl phenylsilane is one of such polysilanes.

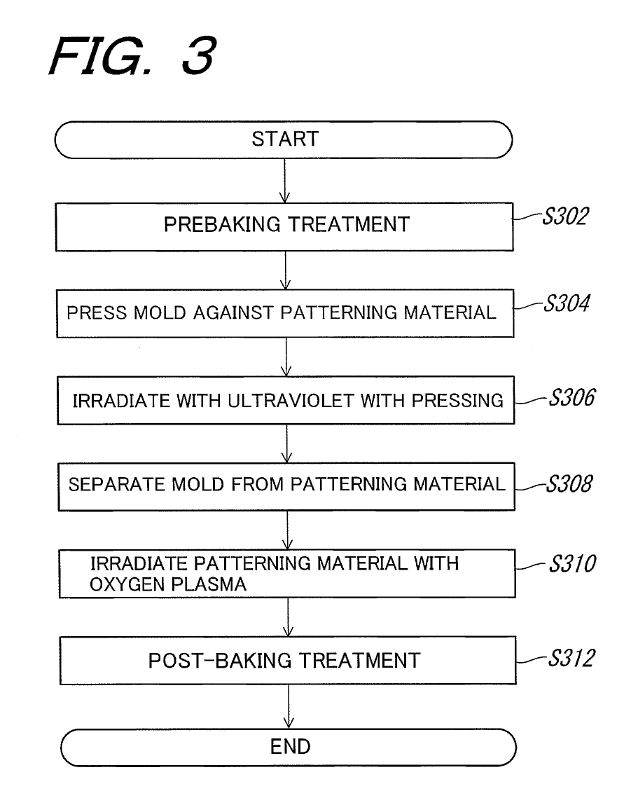

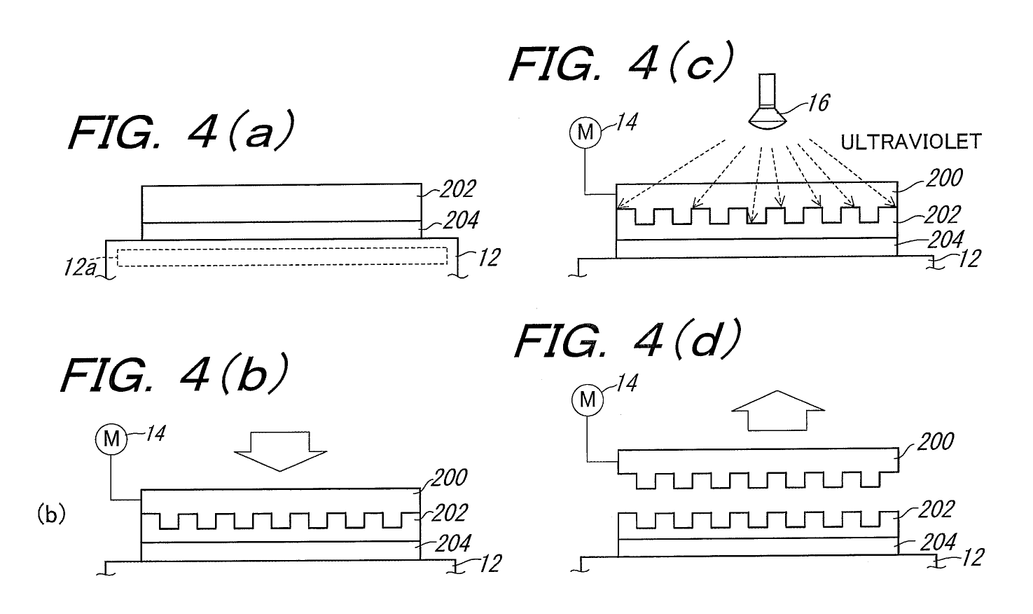

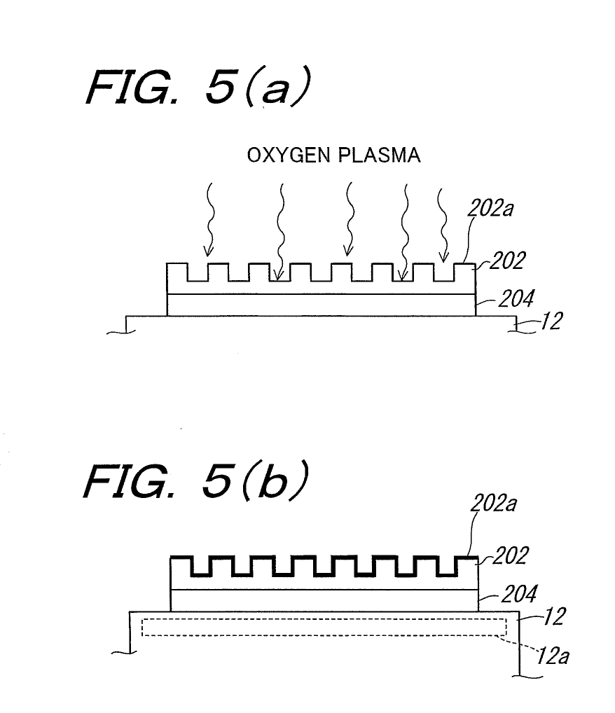

In the following, a nanoimprinting treatment for transferring the fine pattern formed on the mold 200 to the patterning material 202 in accordance with the method of fine-pattern formation of the invention will be described by referring to the flowchart showing processing procedures for the method of a fine-patter formation of the invention shown in FIG. 3 as well as the conceptual explanatory views illustrating the respective steps (which will be mentioned later) in the processing procedures shown in FIGS. 4(a), 4(b), 4(c) and 4(d), and FIGS. 5(a) and 5(b).

In a prebaking treatment step being the first step of the method of fine-pattern formation of the invention, the prebaking treatment is conducted by such a manner that the substrate 204 on which the patterning material 202 has been formed and which has been placed on the sample holder 12 is heated, for example, at 120° C. temperature for 5 minutes by means of the heater 12a (see the step S302 in FIG. 3 and FIG. 4(a)). As a result of the prebaking treatment, the solvent contained in the patterning material 202 vaporizes to be combined uniformly with the substrate 204.

In a pressing treatment step being the second step of the method of fine-pattern formation of the invention, the stepping motor 14 is driven, whereby the mold 200 having a fine structure with recesses/protrusions to be formed is pressed against the patterning material 202 (see the step S304 in FIG. 3 and FIG. 4(b)). The pressing treatment is conducted at a low temperature and low pressure for a short period of time, for example, at a temperature of 80 to 100° C. and a pressure of 2 to 4 MPa for 10 seconds.

In an irradiating treatment step with ultraviolet being the third step of the method of fine-pattern formation of the invention, the superhigh pressure mercury lamp 16 is lit while maintaining the condition wherein the mold 200 is pressed against the patterning material 202 as it stands, whereby the patterning material 202 is irradiated with the ultraviolet involving 365 nm wavelength as the dominant wavelength from the upper direction of the mold 200 for, for example, 5 minutes (see the step S306 in FIG. 3 and FIG. 4(c)). In this case, the output of the superhigh pressure mercury lamp 16 is, for example, 250 W.

Since the mold 200 is made from quartz glass which is transparent with respect to ultraviolet, the ultraviolet transmits the mold 200 so that the patterning material 202 is irradiated therewith, whereby the patterning material is photooxidized.

Namely, the patterning material 202 is irradiated with ultraviolet so that PMPS being the component of the patterning material 202 combines with oxygen, whereby Si—Si bond changes into Si—O—Si bond in the PMPS being the component of the patterning material 202, so that the PMPS changes into a siloxene compound to be vitreous. As a result of combining PMPS with oxygen, the PMPS changes into a siloxene compound to be vitreous, so that cubical expansion of the patterning material 202 arises. Consequently, there is a fear of deforming the fine pattern due to the cubical expansion. Accordingly, it is preferred that the mold 200 is allowed always to be in closely contact with the patterning material 202 in case of the irradiation with ultraviolet.

In the above-described irradiating treatment step with ultraviolet, the whole of the patterning material 202 is photooxidized to be vitreous.

In a releasing treatment step being the fourth step of the method of fine-pattern formation of the invention, the stepping motor 14 is driven to draw up the mold 200 directly above, whereby the mold 200 is drawn from the patterning material 202 (see the step S308 in FIG. 3 and FIG. 4(d)).

In an irradiating treatment step with oxygen plasma being the fifth step of the method of fine-pattern formation of the invention, the patterning material 202 is irradiated with oxygen plasma (O₂ plasma) (see the step S310 in FIG. 3 and FIG. 5(a)). The condition of the irradiation with oxygen plasma is such that, for example, the feed rate is 800 cc, the pressure is 10 Pa, the irradiation time is one minute, and the output is 400 W. As a result of applying the irradiating treatment step with oxygen plasma, the surface 202a of the patterning material 202 on which a fine pattern has been transferred can be oxidized to be rigidified.

Finally, in a post-baking treatment step being the sixth step of the method of fine-pattern formation of the invention, the patterning material 202 to which the treatments of the above-described first to fifth steps were applied is heated by means of the heater 12a at, for example, 350° C. for 5 minutes (see the step S312 in FIG. 3 and FIG. 5(b)). As a result of the post-baking treatment step, the patterning material 202 is completely vitrified through the thermal oxidation, whereby it is mineralized to be hardened.

Namely, when a series of the above-described first to sixth steps is applied at a low temperature and low pressure to the patterning material 202 on which a fine pattern has been formed by pressing the patterning material 202 against the mold 200, the patterning material 202 is photooxidized by the irradiation with ultraviolet to be vitrified; thereafter the patterning material 202 is irradiated with oxygen plasma, whereby the surface thereof is oxidized to be rigidified; and when the patterning material 202 thus treated is heated further, it is completely vitrified to be mineralized.

More specifically, according to the method of fine-pattern formation of the invention, the treatment for transferring the fine pattern formed on the mold 200 to the patterning material 202 may be conducted at a low temperature and low pressure as in a conventional case that an organic material such as PMMA is used for a material of the patterning material 202, while after the fine pattern formed on the mold 200 is once transferred to the patterning material 202, the patterning material 202 is vitrified and mineralized. As a consequence, the patterning material 202 thus treated exhibits excellent properties of water absorption, chemical resistance, heat resistance, and hardness so that the fine pattern formed on the patterning material 202 is not easily deformed.

Hence, a fine pattern having excellent water absorption property, chemical resistance, heat resistance and hardness, besides there is no fear of deformation can be formed on the patterning material 202 at a low temperature and low pressure for a short period of time in accordance with the method of fine-pattern formation of the invention.

In the above-described method of fine-pattern formation of the invention, the above-described sixth step of the post-baking treatment step can improve remarkably the chemical resistance of the patterning material 202. Namely, a most part of the patterning material 202 is vitrified as a result of irradiation with ultraviolet in the irradiating treatment step with ultraviolet being the preceding step of the post-baking treatment step. Accordingly, when the patterning material 202 in this condition is compared with that of the untreated one, i.e. the patterning material 202 being in a condition of polysilane before the irradiating treatment step with ultraviolet is conducted, the former patterning material 202 exhibits dramatically improved chemical resistance, but it dissolves slightly in acetone.

As a result of the post-baking treatment step, for instance, when the post-baking treatment is conducted at a temperature of around 350° C., complete vitrification of the patterning material 202 is achieved, so that the chemical resistance thereof is remarkably improved and the resulting patterning material 202 does not become dissolved in acetone.

In the following, the experimental results made by the inventor(s) of the application will be described wherein polymethyl phenylsilane is used as a polysilane.

According to the experimental results made by the inventor(s), concerning the patterning material 202 on which a fine pattern was formed through a series of the above-described first to sixth steps, it is confirmed that there is a heat resistance at 350° C. up to 5 minutes; that it is insoluble in dilute hydrochloric acid; that it is insoluble even when ultrasonic cleaning is applied to the patterning material 202 in acetone, toluene, and anisole for one minute; and that 70% or more of light having a wavelength of up to 300 nm transmit, and further 90% or more of light which has a wavelength of up to 350 nm transmit the patterning material 202.

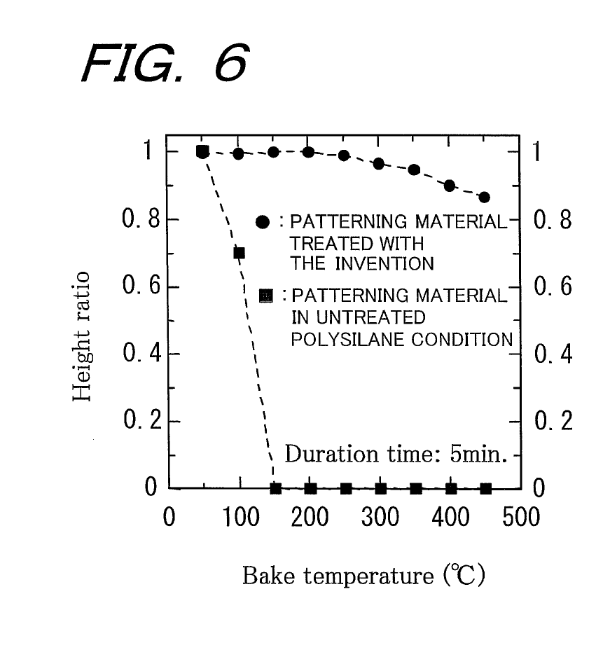

More specific explanation will be made hereunder. FIG. 6 is a graph showing the experimental results as to the height ratio dependency of post-baking temperatures made by the inventor(s) wherein the abscissa indicates post-baking temperatures (bake temperature), and the ordinate indicates height ratios in which the height ratio is a ratio of heights in fine patterns with respect to a mold; and the duration time for post-baking is 5 minutes.

As shown in the graph of FIG. 6, concerning the patterning material to which no irradiating treatment step with ultraviolet and irradiating treatment step with oxygen plasma are applied, in other words, the patterning material being in a polysilane condition (hereinafter referred to as “untreated polysilane-conditioned patterning material”), the height ratio thereof is zero, namely, the fine pattern thereof disappears in a post-baking treatment at a temperature of 150° C. or higher.

On the other hand, concerning the patterning material to which the irradiating treatment step with ultraviolet and irradiating treatment step with oxygen plasma are applied in accordance with the method of fine-pattern formation of the invention (hereinafter referred to as “treated patterning material of the invention”), the fine-pattern contour thereof can be completely maintained at a post-baking temperature of up to 250° C. Furthermore, when a post-baking treatment is conducted at 350° C. for 5 minutes, very small shrinkage of 5% is observed, but the fine-pattern contour is maintained.

Namely, the fine pattern of the treated patterning material of the invention has very high heat resistance. In this connection, it may be considered that a thermal history remains in the patterning film as a result of the post-baking treatment, so that the fine pattern withstands the heat treatment up to the temperature concerned.

Furthermore, according to the inventor(s)' experiment, the contour of the fine pattern formed on the patterning material 202 does not change and exhibits excellent chemical resistance as a result of conducting such post-baking treatment at 350° C. for 5 minutes in the above-described sixth step of the post-baking treatment step, even when the following enumerated treatments are applied:
ultrasonic cleaning in acetone for 30 minutes;
immersion into 10% aqueous HCl solution for 30 minutes;
immersion into 10% aqueous NaOH solution for 30 minutes; and
immersion into 5% aqueous HF solution for 30 minutes.

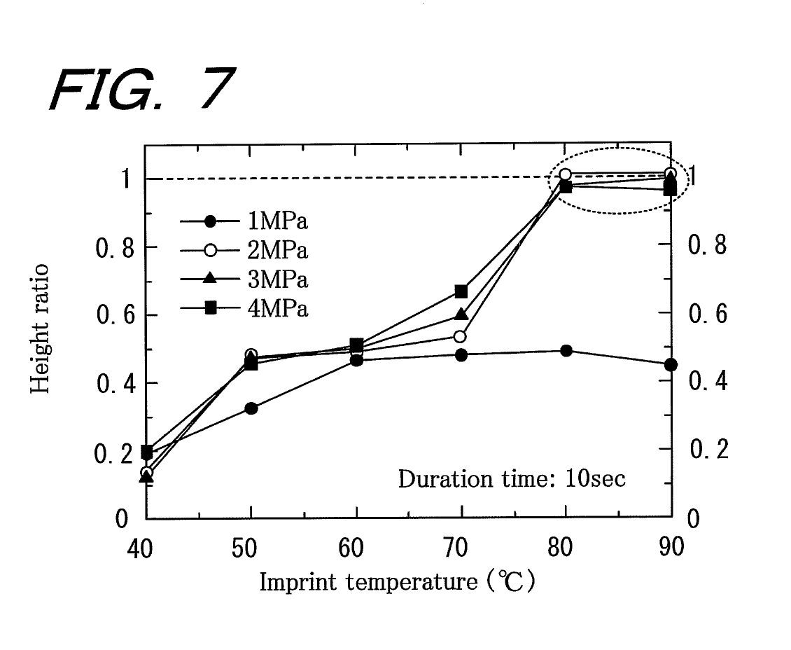

Next, concerning the condition in case of pressing the mold 200 against the patterning material 202 in the pressing treatment step, it is confirmed that imprint is possible at a low temperature of 80° C. and low pressure of 2 MPa for a short time of 10 seconds as in the experimental results shown in the graph of FIG. 7 indicating the dependency among temperatures, pressures, and periods of time in case of the pressing treatment. In FIG. 7, the abscissa indicates temperatures (imprint temperatures) in case of pressing treatment and the ordinate indicates height ratios; and the duration time in case of pressing treatment is 10 seconds.

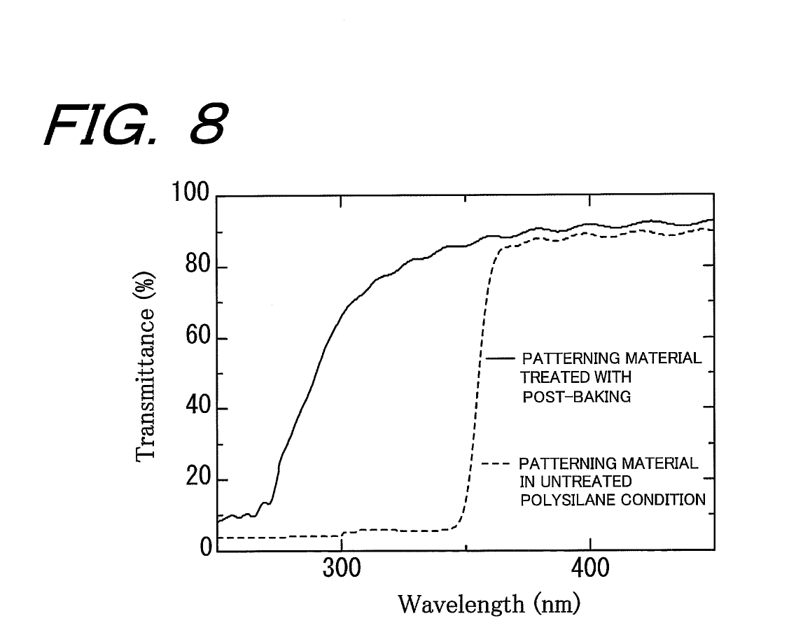

Next, FIG. 8 is a graph showing the experimental results as to ultraviolet transmittability made by the inventor(s) of the application wherein the abscissa indicates wavelengths, and the ordinate indicates transmittances. As shown in FIG. 8, it is confirmed that 70% or more of light having a wavelength of up to 300 nm transmit, and 90% or more of light having a wavelength of up to 350 nm transmit the patterning material obtained by applying the post-baking treatment to the treated patterning material of the invention (hereinafter referred to as “postbake-treated patterning material”). In other words, the postbake-treated patterning material is transparent in visible region.

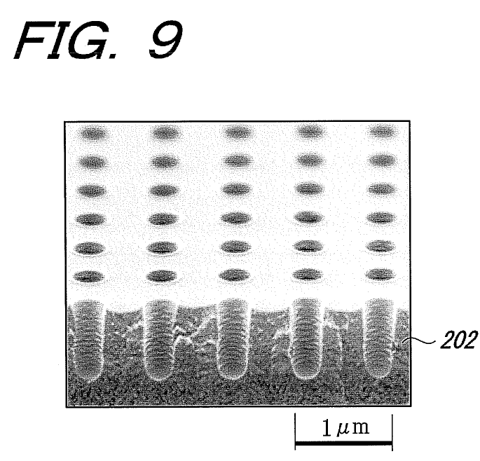

According to the method of fine-pattern formation of the invention, it is possible to form a pattern having a high aspect ratio structure. According to the experimental results made by the inventor(s) of the application, a high aspect ratio of 3.5 can be achieved by the patterning material 202 on which a fine pattern was formed through a series of the above-described first to sixth steps as shown in FIG. 9 which is an explanatory view showing a condition of the patterning material observed by a scanning electron microscope.

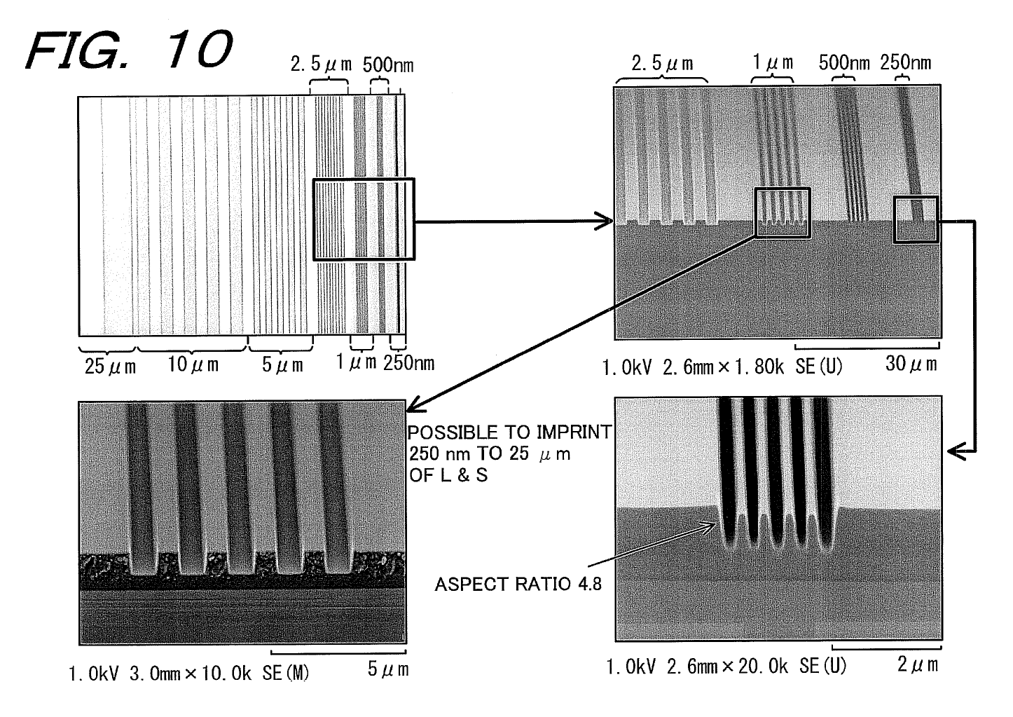

Moreover, according to the method of fine-pattern formation of the invention, a high aspect ratio of 4.8 is achieved with respect to L & S (line and space) of 250 nm as shown in FIG. 10 which is an explanatory view showing a condition of the patterning material observed by a scanning electron microscope.

Concerning imprinting, it is known that there is a dependency among size, contour, and density in patterning. This means that there are a case wherein patterning can be completely achieved and a case wherein patterning cannot completely be achieved dependent on size, contour, and density of the patterning, since the fluidity of a patterning material differs remarkably dependent on the imprinting condition.

According to the method of fine-pattern formation of the invention, the patterning in line and space of 250 nm to 25 μm the magnitudes of which differ by two digits is possible under the above-described condition at the low temperature of 80° C. and low pressure of 2 MPa for the short period of time of 10 seconds (see FIG. 10).

Since the magnitude of 250 nm is around the wavelength of light, the patterning of a photonic crystal or the like becomes possible in accordance with the method of fine-pattern formation of the invention. On one hand, since the magnitude of 25 μm is substantially equal to the width of flow channel of a biochip, the patterning of the flow channel of a biochip becomes possible in accordance with the method of fine-pattern formation of the invention.

Namely, it becomes possible to pattern a variety of devices by selecting one condition with respect to polysilane according to the method of fine-pattern formation of the invention.

Furthermore, it is also possible to form a pattern smaller than 250 nm, and a pattern larger than 25 μm according to the method of fine-pattern formation of the invention.

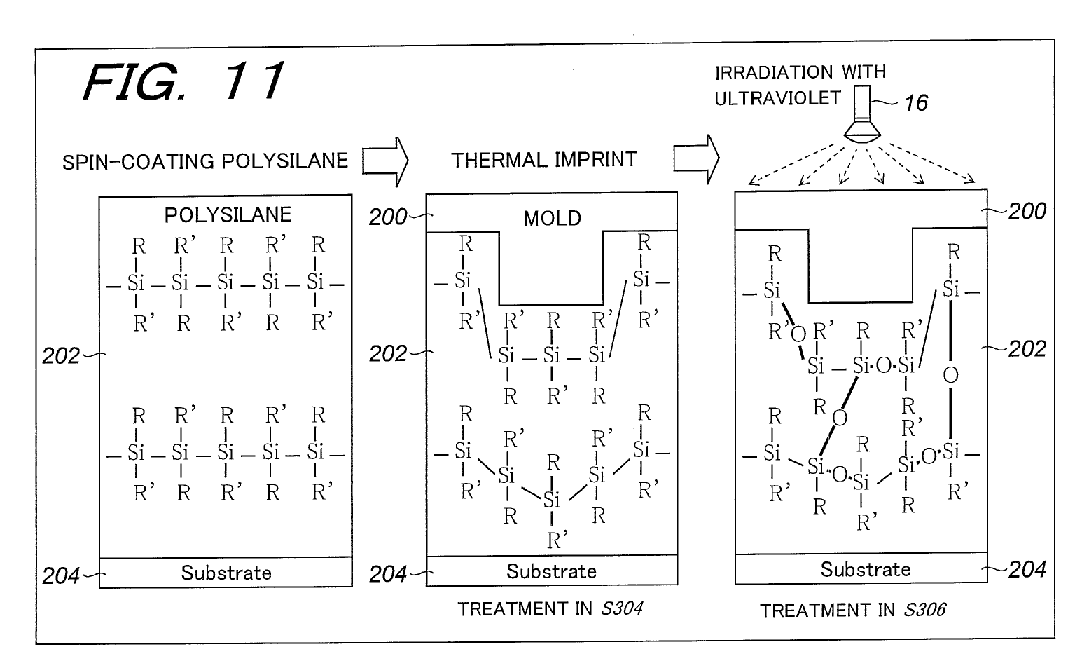

As described above, the method of fine-pattern formation of the invention is a manner wherein polysilane is thermally imprinted at a low temperature and low pressure for a short period of time (the treatment in the step S304), and then the polysilane is irradiated with ultraviolet to crosslink the polysilane to be cured (the treatment in the step S306) as shown in FIG. 11.

In the case that conventional glass is used for a patterning material, a process of a high temperature of 500° C. is required, because the melting point of glass is high. However, in the method of fine-pattern formation of the invention, patterning can be conducted at a low temperature of 80° C. The reason therefor is in that polysilane being a patterning material has a simple straight-chained structure, so that it is easily deformed, whereby deformation occurs easily at a low temperature and low pressure for a short time.

In this respect, however, to be deformable at a low temperature means that there is a fear of easy deforming of the pattern formed from the mold 200. According to the method of fine-pattern formation of the invention, the mold 200 pressed against the patterning material 202 made from polysilane is irradiated with ultraviolet while maintaining the condition of the mold 200 and the patterning material 202 as it stands, whereby the surrounding polysilane chains are crosslinked through photooxidation to be cured in vitrescent in order to prevent the deformation of the pattern.

The above-described first embodiment may be modified as described in the following paragraphs (1) through (4).

(1) In the above-described first embodiment, although the superhigh pressure mercury lamp 16 has been placed in the position over the nanoimprint apparatus 10, the superhigh pressure mercury lamp 16 may be placed in an arbitrary position from which ultraviolet can be irradiated with respect to the patterning material 202 so that the position where the superhigh pressure mercury lamp 16 is to be placed is not restricted, because the purpose for using the superhigh pressure mercury lamp 16 is to irradiate ultraviolet with respect to the patterning material 202.

(2) In the first embodiment, although it is arranged in such that the mold 200 is made from quartz glass; and ultraviolet transmits the mold 200 to irradiate the patterning material 202, the invention is not limited thereto as a matter of course, but it may be arranged in such that the substrate 204 on which the patterning material 202 is to be formed is made from quartz glass through which ultraviolet transmits; and ultraviolet transmits the substrate 204 to irradiate the patterning material 202.

(3) In the above-described first embodiment, although the patterning material 202 is irradiated with ultraviolet having 365 nm wavelength as the dominant wavelength, a wavelength of the ultraviolet may be suitably selected within a range of 300 to 400 nm. Irradiation with ultraviolet is to supply such energy required for cutting off Si—Si a bonds.

In addition, vitrification of the patterning material 202 in the above-described irradiating treatment step with ultraviolet depends on the function of a film thickness of the patterning material 202 and an irradiation time with ultraviolet. Accordingly, appropriate values may be selected for vitrifying the patterning material 202 with respect to the film thickness of the patterning material 202 and the irradiation time with ultraviolet by evaluating the peak judgment by means of FT-IR, changes in refractive index and the like. According to the experiments made by the inventor(s) of the application, the whole film of the patterning material 202 can be substantially vitrified by irradiating with ultraviolet having a wavelength of 300 to 400 nm for 3 to 5 minutes in the case that a film thickness of the patterning material 202 made from polymethyl phenylsilane is around 2 μm.

(4) The above-described first embodiment may suitably be combined with the above-described paragraphs (1) through (3).

### Second Embodiment

Next, the second embodiment of the method of fine-pattern formation of the invention will be described wherein the detailed description of the same or equal constitutions, functions, and treatment contents with or to those of the first embodiment of the method of fine-pattern formation of the invention as described above will be optionally omitted by indicating or applying the same terms or reference characters as that of the first embodiment.

The method of fine-pattern formation according to the second embodiment of the invention differs from that of the first embodiment in the following points.

Namely, it is arranged in the first embodiment in such that the mold 200 is irradiated with ultraviolet from the side of the mold 200 to transmit the mold 200, and then the patterning material 202 is irradiated with the ultraviolet during the series of treatment steps, or that the substrate 204 on which the patterning material 202 is to be formed is made from a material such as SiO₂ through which ultraviolet transmit, and the substrate 204 is irradiated with ultraviolet from the side of the substrate 204 to transmit the substrate 204, and then the patterning material 202 is irradiated with the ultraviolet, whereby the whole patterning material 202 is photooxidized to be vitrified. Namely, the whole patterning material 202 is once irradiated with ultraviolet to be photooxidized and vitrified in the first embodiment.

On the other hand, ultraviolet is irradiated twice in the second embodiment, i.e. the first irradiation is such that a patterning material 202 is irradiated with ultraviolet from the side of a substrate 204; and the second irradiation is such that the patterning material 202 is irradiated with ultraviolet from the side of a mold 200.

Under the circumstances, in the first irradiation wherein the patterning material 202 is irradiated with ultraviolet from the side of the substrate 204, photooxidation of the patterning material 202 is conducted in such condition that a polysilane region remains in the vicinity of a boundary face between the mold 200 and the patterning material 202 made of polysilane so as not to firmly fix the boundary face.

As described in the first embodiment, since vitrification of the patterning material 202 depends on the function of a film thickness of the patterning material 202 and an irradiation period of time of ultraviolet, appropriate values may be selected from the film thicknesses of the patterning material 202 and the irradiation periods of time of ultraviolet by evaluating the peak judgment with FT-IR, changes in refractive index and the like in order that the patterning material 202 is vitrified so as to remain the polysilane region in the vicinities of the boundary face between the mold 200 and the patterning material 202.

In the first irradiation with ultraviolet as described above, the firm fixation of the mold 200 and the patterning material 202 is suppressed to retain the releasability between the mold 200 and the patterning material 202, so that the mold 200 may be easily released from the patterning material 202.

After the mold 200 is released from the patterning material 202, the second irradiation with ultraviolet is conducted from the side of the mold 200 so as to photooxidize the polysilane region left on the patterning material 202, whereby whole the patterning material 202 is photooxidized to vitrify completely the entire patterning material 202.

According to the second embodiment as described above, the following excellent functions and effects are achieved:

(1) Due to improvements in the releasability between the mold 200 and the patterning material 202, a yield ratio of pattern formation in the patterning material 202 is elevated;

(2) The adhesion between the substrate 204 and the patterning material 202 made from polysilane is improved; and

(3) The entire mineralization of polysilane is achieved by irradiating the polysilane with ultraviolet from the upper and lower positions of the patterning material 202, i.e. both the sides of the substrate 204 and the mold 200, so that thermal oxidation by the post-baking treatment can be conducted at a low temperature of 200° C. or less. (The post-baking treatment in the first embodiment is conducted at, for example, 350° C., whereby the entire mineralization of the patterning material 202 is implemented through the thermal oxidation.)

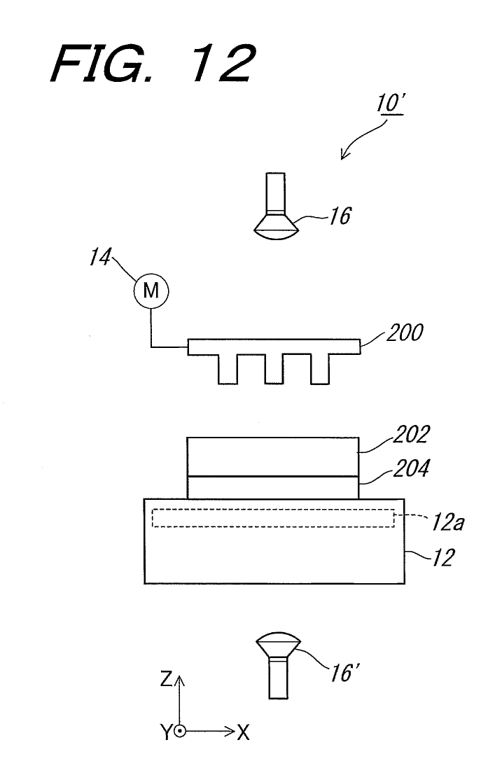

In the following, the above-described second embodiment of the method of fine-pattern formation of the invention will be described in detail. For instance, a nanoimprint apparatus 10′ shown in FIG. 12 is used for pressing the mold against the patterning material in case of implementing the second embodiment of the method of fine-pattern formation of the invention.

First, the nanoimprint apparatus 10′ differs from the nanoimprint apparatus 10 shown in FIG. 2 in that a superhigh pressure mercury lamp 16′ for irradiating the patterning material 202 with ultraviolet is placed in the lower position of a sample holder 12.

In the nanoimprint apparatus 10′, the sample holder 12 and the heater 12a are suitably disposed in such that the patterning material 202 may be irradiated with ultraviolet from the lower position of the sample holder 12, besides the substrate 204 is made from SiO₂ through which ultraviolet transmits.

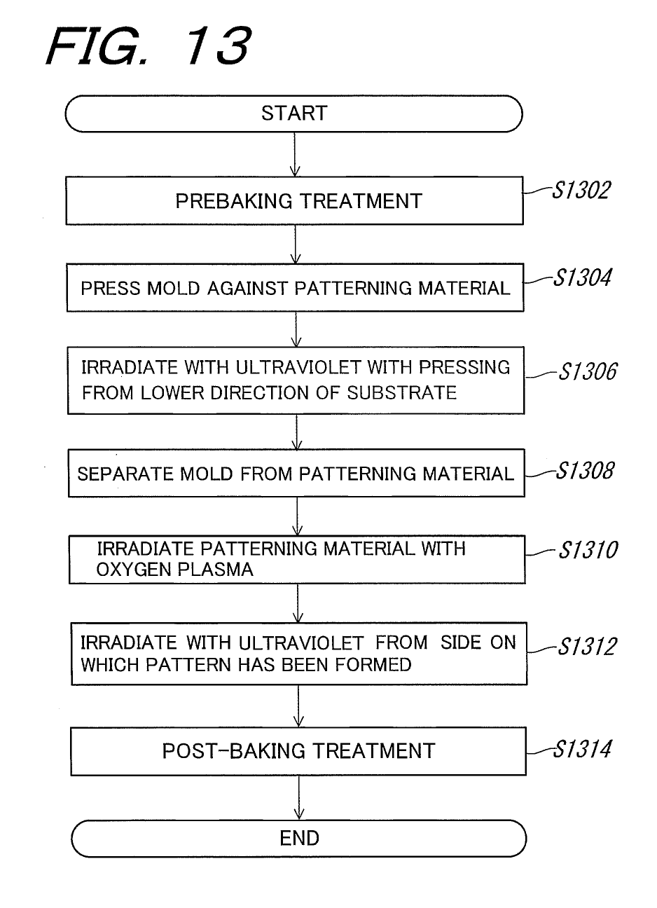

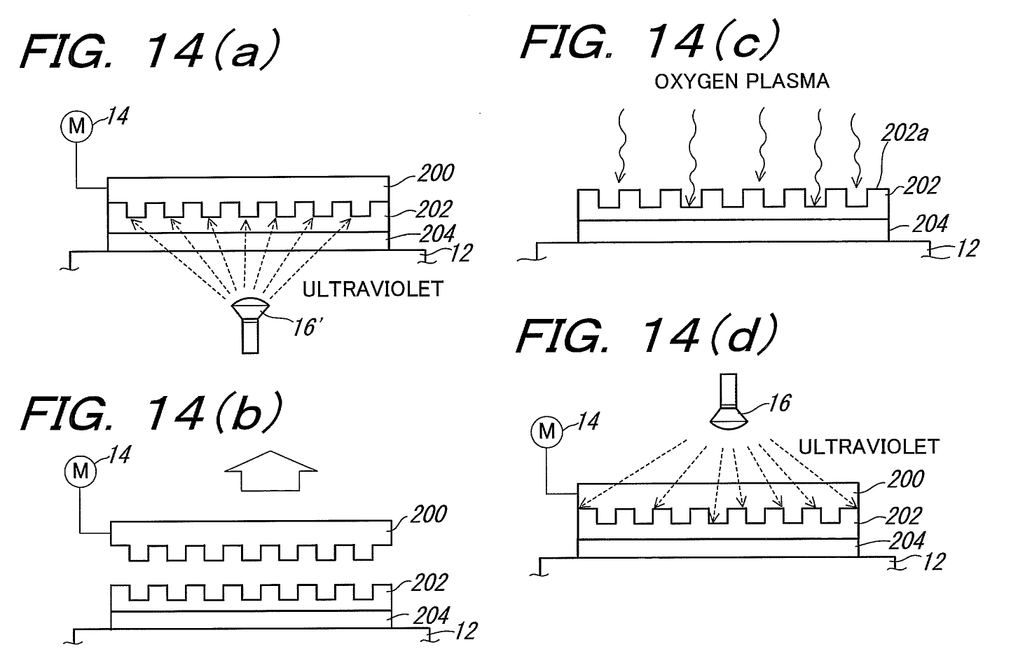

Next, a nanoimprint treatment for transferring the fine pattern formed on the mold 200 to the patterning material 202 in accordance with the method of fine-pattern formation of the invention will be described by referring to a flowchart of FIG. 13 showing treatment procedures of the method of fine-pattern formation of the invention as well as conceptual explanatory views of FIGS. 14(a), 14(b), 14(c), and 14(d) showing respective steps (which will be mentioned later) in the treatment procedures.

A first step of a prebaking treatment step (step S1302) is the same treatment as the prebaking treatment step (the step S302 and FIG. 4(a)) in the first embodiment, and a second step of pressing treatment step (step S1304) is the same treatment as the pressing treatment step (the step S304 and FIG. 4(b)) in the first embodiment. Accordingly, the detailed explanation therefor is omitted.

Then, when the second step of the pressing treatment step (the step S1304) is completed, a third step of a first irradiating treatment step with ultraviolet according to the method of fine-pattern formation of the invention is conducted in such that the superhigh pressure mercury lamp 161 is lit while maintaining the condition wherein the mold 200 is pressed against the patterning material 202 as it stands, whereby the patterning material 202 is irradiated with the ultraviolet involving 365 nm wavelength as the dominant wavelength from the lower direction of the substrate 204 (see step S1306 and FIG. 14(a)). In this case, the output of the superhigh pressure mercury lamp 16′ is, for example, 250 W.

The sample holder 12 and the heater 12a are suitably positioned in such that the patterning material 202 may be irradiated with ultraviolet from the lower position of the sample holder 12, and further the substrate 204 is made from SiO₂ through which ultraviolet transmits. Consequently, the ultraviolet transmits the substrate 204 so that the patterning material 202 is irradiated with ultraviolet, whereby the patterning material 202 is photooxidized.

It is to be noted that the vitrification due to the photooxidation through the irradiation of the patterning material 202 with ultraviolet is the same as that of the above-described first embodiment, and accordingly, the explanation therefor is omitted.

Furthermore, in the first irradiating treatment step with ultraviolet, the patterning material 202 is photooxidized in such condition that a polysilane region remains in the vicinity of a boundary face between the mold 200 and the patterning material 202 made from polysilane so as not to firmly fix the boundary face.

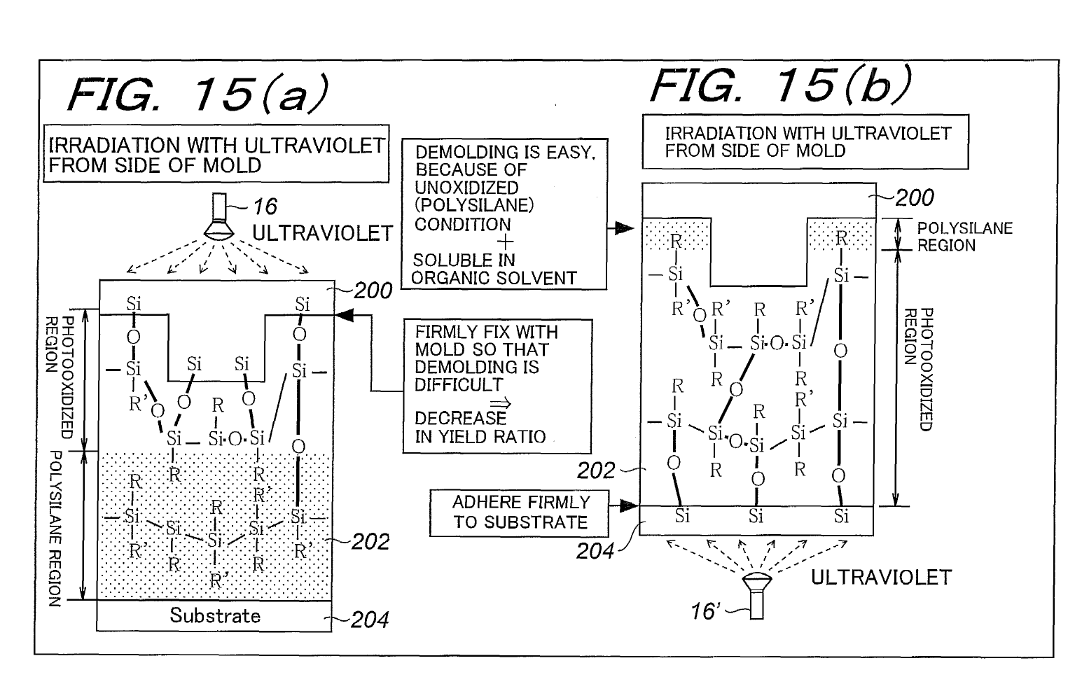

Namely, this is because the photooxidation of the patterning material 202 starts from the side of the mold 200, when the superhigh pressure mercury lamp 16 is lit first to irradiate the patterning material 202 with ultraviolet in case of irradiating the patterning material 202 with ultraviolet. Accordingly, when the mold 200 is made from SiO₂ or the like which is the same material as that of the patterning material 202, the patterning material 202 fixes firmly to the mold 200, so that it becomes difficult to release the mold 200 from the patterning material 202 (see FIG. 15(a)).

For this reason, in the second embodiment, such a manner that first, the superhigh mercury lamp 16′ is lit to conduct irradiation with ultraviolet from the side of the substrate 204 so as not to firmly fix the boundary face between the mold and the patterning material 202 made from polysilane, but to remain a polysilane region in the vicinities of the boundary face (see FIG. 15(b)) in the case that the patterning material 202 is irradiated with ultraviolet.

Namely, the irradiation with ultraviolet in the first irradiating treatment step with ultraviolet is conducted by controlling the irradiation time and the power therefor so as not to photooxidize completely up to the boundary face between the mold 200 and the patterning material 202 made from polysilane. As a consequence, the boundary face of the mold 200 and the patterning material 202 made from polysilane remains in a condition of polysilane, so that the mold 200 is easily released.

Moreover, adhesion of the patterning material 202 with the substrate 204 made from SiO₂ increases, so that exfoliation of polysilane from the substrate 204 decreases dramatically in the case that the mold 200 is released from the patterning material 202.

Next, when the third step of the first irradiating treatment step with ultraviolet (the step S1306) is completed, it proceeds to a fourth step of a releasing treatment step (see step S1308 and FIG. 14(b)). When the fourth step of the releasing step (the step S1308) is completed, the process proceeds to a fifth step of an irradiating treatment step with oxygen plasma (see step S1310 and FIG. 14(c)).

Since a fourth step of a releasing treatment step (step S1308) is the same treatment as the releasing treatment step (the step S308 and FIG. 4(d)) in the first embodiment, and a fifth step of irradiating treatment step with oxygen plasma (step S1310) is the same treatment as the irradiating treatment step with oxygen plasma (the step S310 and FIG. 5(a)) in the first embodiment. Accordingly, the detailed explanation therefor is omitted.

Then, when the fifth step of the irradiating treatment step with oxygen plasma (the step S1310) is completed, a sixth step of a second irradiating treatment step with ultraviolet according to the method of fine-pattern formation of the invention is conducted in such that the superhigh pressure mercury lamp 16 is lit, whereby the patterning material 202 from which the mold 200 is released is irradiated with the ultraviolet involving 365 nm wavelength as the dominant wavelength from the side thereof on which a pattern has been formed from the mold 200 (see step S1312 and FIG. 14(d)). In this case, the output of the superhigh pressure mercury lamp 16 is, for example, 250 W.

As a result of the second irradiating treatment step with ultraviolet, the polysilane region of the patterning material 202 which has not yet been photooxidized in the first irradiating treatment step with ultraviolet is photooxidized to vitrify the whole pattering material 202.

Next, when the sixth step of the second irradiating treatment step with ultraviolet (the step S1312) is completed, the process proceeds to a seventh step of a post-baking treatment step (step S1314).

Since the seventh step of post-baking treatment step (the step S1314) is the same treatment as the post-baking treatment step (the step S312 and FIG. 5(b)) in the first embodiment, the detailed explanation therefor is omitted.

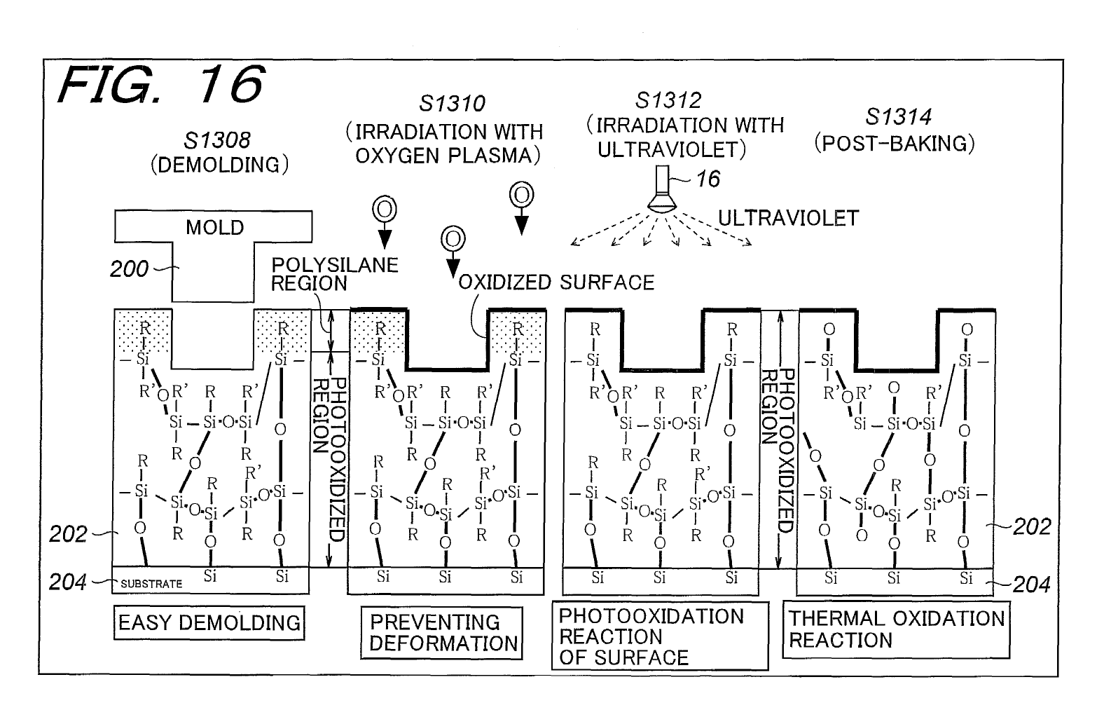

More specifically, in the second embodiment, a polysilane region remains on the upper part of the patterning material 202, i.e. in the region wherein a pattern has been formed by only the first irradiating treatment step with ultraviolet (the step S1306). It results in deterioration of mechanical strength and chemical resistance. For this reason, mineralizing steps of the irradiating treatment step with oxygen plasma (the step S1310), the second irradiating treatment step with ultraviolet (the step S1312), and the post-baking treatment step (the step S1314) are applied after releasing of the patterning material 202, whereby the whole of a pattern inclusive of the region which has not yet been photooxidized by the first irradiating treatment step with ultraviolet (the step S1306) is vitrified (see FIG. 16).

In the second embodiment, two types of mineralization steps, i.e. the photooxidation by means of the second irradiating treatment step with ultraviolet (the step S1312), and the thermal oxidation by means of the post-baking treatment step (the step S1314) are applied. In order to suppress that a pattern becomes dull due to irradiation with ultraviolet and post-baking, the surface of a polysilane region is oxidized by the irradiating treatment step with oxygen plasma (the step S1310) to make the surface to be a rigid film before the second irradiating treatment step with ultraviolet (the step S1312) is applied. Thereafter, the polysilane region is photooxidized by the second irradiating treatment step with ultraviolet, and then, the crosslinkage in the polysilane region is allowed to proceed further by means of the post-baking treatment thereby to cure the polysilane region.

In the following, the experimental results made by the inventor(s) of the application will be described wherein polymethyl phenylsilane is used as polysilane.

First, the experiment wherein changes in chemical resistance due to post-baking treatment are examined will be described. In the experiment for examining chemical resistance, the samples patterned in the first embodiment and the samples patterned in the second embodiment are subjected to ultrasonic cleaning, respectively, and conditions of the respective samples after cleaning are observed.

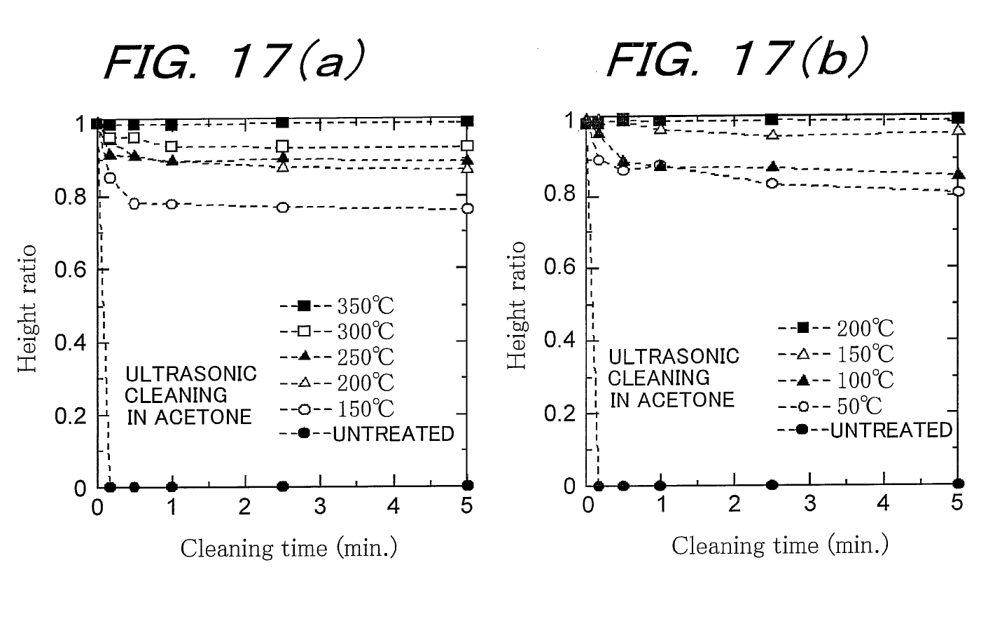

FIGS. 17(a) and 17(b) are graphs showing the experimental results as to the above-described changes in chemical resistance wherein FIG. 17(a) shows experimental results of the samples patterned in the first embodiment, while FIG. 17(b) shows experimental results of the samples patterned in the second embodiment. In the graphs of FIGS. 17(a) and 17(b), the abscissa indicates cleaning times, and the ordinate indicates height ratios. The height ratio corresponds to “height ratio the height of a pattern after cleaning)/the height of the pattern immediately after post-baking treatment”.

It is to be noted that the samples patterned in the first embodiment used for the experiment are a sample to which no post-baking treatment is applied (indicated by “untreated” in FIG. 17(a)), a sample to which the post-baking treatment is applied at 150° C. (indicated by 150° C. in FIG. 17(a)), a sample to which the post-baking treatment is applied at 200° C. (indicated by “200° C.” in FIG. 17(a)), a sample to which the post-baking treatment is applied at 250° C. (indicated by “250° C.” in FIG. 17(a)), a sample to which the post-baking treatment is applied at 300° C. (indicated by “300° C.” in FIG. 17(a)), and a sample to which the post-baking treatment is applied at 350° C. (indicated by “350° C.” in FIG. 17(a)), respectively.

On one hand, the samples patterned in the second embodiment used for the experiment are a sample to which no post-baking treatment is applied (indicated by “untreated” in FIG. 17(b)), a sample to which the post-baking treatment is applied at 50° C. (indicated by “50° C.” in FIG. 17(b)), a sample to which the post-baking treatment is applied at 100° C. (indicated by “100° C.” in FIG. 17(b)), a sample to which the post-baking treatment is applied at 150° C. (indicated by “150° C.” in FIG. 17(b)), and a sample to which the post-baking treatment is applied at 200° C. (indicated by “200° C.” in FIG. 17(b)), respectively.

According to the experimental results, the patterns disappear completely by ultrasonic cleaning for 10 seconds from both the untreated samples in the samples patterned in the first embodiment and the samples patterned in the second embodiment, in other words, the disappeared samples are those involving the region on which a pattern was formed remains in the form of a polysilane region.

Moreover, according to the first embodiment, whole the pattern is vitrified by thermal oxidation in order to assure that the pattern does not change even if the cleaning time is prolonged. Consequently, baking at 350° C. is required as the post-baking treatment. On the other hand, sufficient chemical resistance is achieved by even baking at 200° C. according to the second embodiment.

Thus, according to the second embodiment, a material as to which heat treatment is undesired (e.g. an organic material) may be used simultaneously, besides there is no thermal shrinkage of polysilane at 200° C., so that it is no need to take such kind of thermal shrinkage into consideration.

Namely, the whole polysilane is oxidized by the thermal oxidation in the post-baking treatment so that baking at 350° C. is required, and finally around 5% of shrinkage appears in the first embodiment. According to the second embodiment, however, since the whole pattern is vitrified by the photooxidation through irradiation with ultraviolet, the pattern contour just formed from the mold 200 can be retained in even acetone.

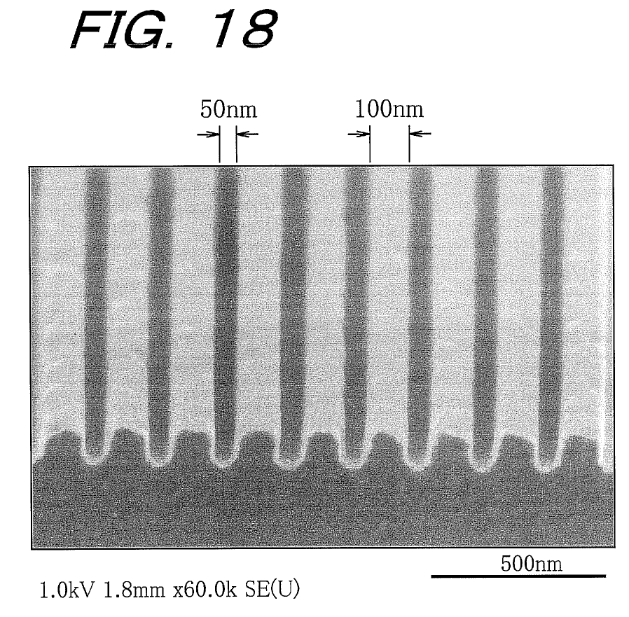

Furthermore, in the method of fine-pattern formation according to the second embodiment of the invention, L & S (Line and space) of 50 nm can be achieved in a sample which is imprinted at a low temperature of 80° C. and low pressure of 2 MPa for a short period of time of 10 seconds in the same condition as that of the above-described first embodiment as shown in FIG. 18 being an explanatory view showing the condition observed by a scanning electron microscope; and in this case, its aspect ratio is around 2.

In other words, when the method of fine-pattern formation according to the second embodiment of the invention is applied, it is possible to conduct, for example, patterning of 50 nm structure at a low temperature of 80° C. and low pressure of 2 MPa for a short period of time of 10 seconds.

It is to be noted that even when the method of fine-pattern formation according to the first embodiment of the invention is applied, the same result as that shown in FIG. 18 is obtained.

Namely, when the method of fine-pattern formation according to the invention is applied, a structure having a nanometer order of 50 nm to a micrometer order of 25 μm can be fabricated. Accordingly, it is also possible to pattern a structure having 50 nm or less, and further to pattern a structure having remarkably different details extending over from 50 nm to 25 μm or a structure having a high aspect ratio in a lump. Although such a comprehensive transfer of a pattern having remarkably different details or a structure having a high aspect ratio is impossible with a usual glass material, but it may be achieved in accordance with the method of fine-pattern formation of the invention wherein polysilane is used.

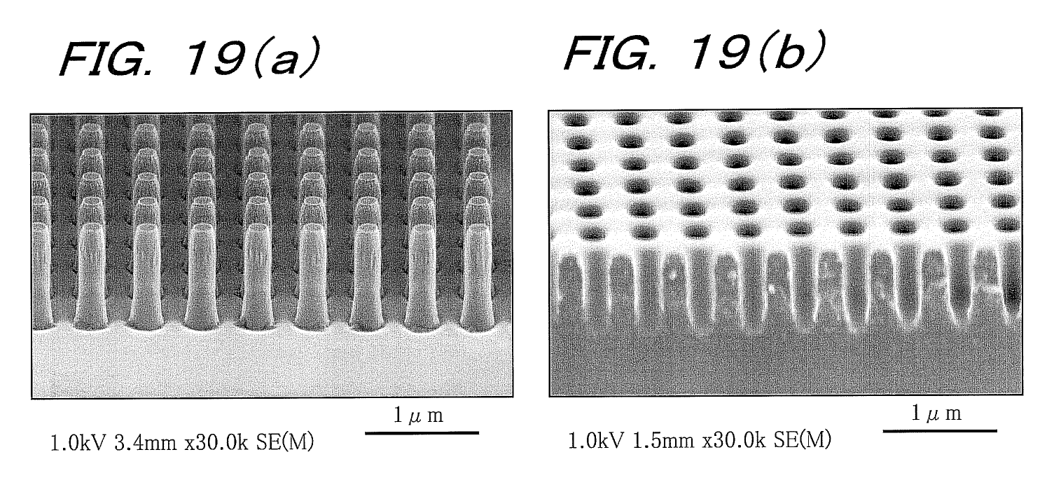

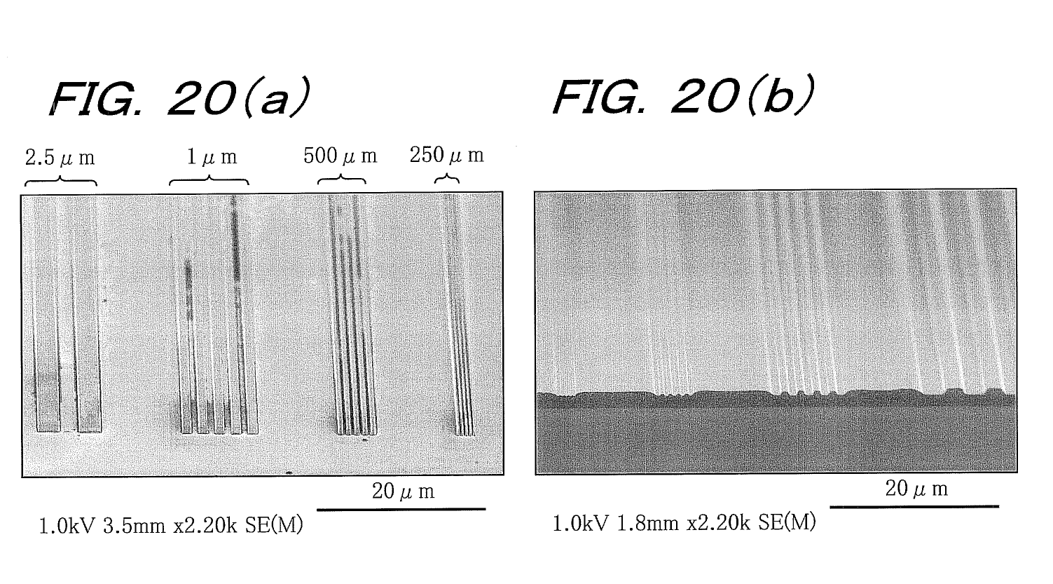

Moreover, according to the method of fine-pattern formation of the second embodiment of the invention, even when the temperature condition of 80° C. is changed to room temperature in the above-described condition of 80° C., 2 MPa, and 10 seconds, a pattern can be formed on the patterning material 202 as shown in the explanatory views of FIGS. 19(a) and 19(b) as well as FIGS. 20(a) and 20(b) showing the conditions observed by a scanning electron microscope.

Namely, FIG. 19(a) and FIG. 20(a) show the mold 200, respectively, while FIG. 19(b) and FIG. 20(b) show the patterning material 202 imprinted from the mold 200, respectively, wherein the substantially complete patterning can be observed in case of the air-hole structures shown in FIGS. 19(a) and 19(b), while there are incomplete cases in L & S (line and space) pattern cases shown in FIGS. 20(a) and 20(b); and in this connection, it is considered that pattern precision depends on the contour, size and the like of a structure so that optimization through applications is required.

When the method of fine-pattern formation according to the second embodiment of the invention is applied, imprinting can be achieved at room temperature as described above, so that steps for rising and dropping temperatures become unnecessary, whereby it becomes possible to reduce the processing time, for instance, a time heretofore required for one minute may be reduced to a half thereof, i.e. thirty seconds.

It is to be noted that even when the method of fine-pattern formation according to the first embodiment of the invention is applied, the same results as that shown in FIGS. 19(a) and 19(b) as well as FIGS. 20(a) and 20(b) are obtained.

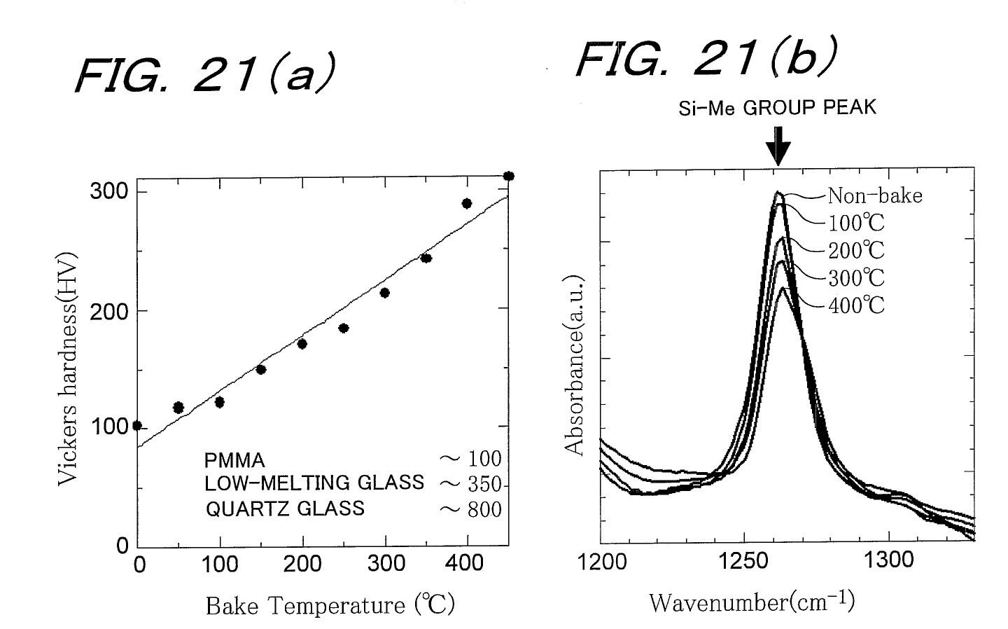

Furthermore, the Vickers hardness is improved with rise of the bake temperature in the post-baking treatment as shown in FIG. 21(a) by the method of fine-pattern formation according to the second embodiment of the invention. More specifically, Vickers hardness 300 HV is obtained in the case that a pattern is subjected to post-baking treatment at 450° C., so that substantially the same hardness as that of low-melting glass is achieved. Moreover, since Vickers hardness of PMMA is 100 HV, the above result means that around tripled Vickers hardness than that of PMMA is obtained. There is further such possibility that a material having a higher hardness is obtained by baking a pattern at a temperature of 450° c. or more.

It has been found by the FT-IR measurement with the use of Fourier transform infrared spectroscopic analyzer (FT-IR) (see FIG. 21(b)) that such increase in hardness is due to the desorption of the functional groups (methyl groups) combined with the side chains of polysilane as a result of increase in the bake temperature in a post-baking treatment. From the graph shown in FIG. 21(b), it is considered that there is a possibility of the increase in hardness by further baking; and it is also considered that when the functional group is replaced by other functional groups which are easily detached from the methyl chains of polysilane (for example, phenyl groups), it becomes possible to pattern a material having a higher hardness by baking at a further lower temperature.

The above-described second embodiment may be modified as shown in the following paragraphs (1) through (3).

(1) In the above-described second embodiment, although the patterning material 202 is irradiated with ultraviolet having 365 nm wavelength as the dominant wavelength, a wavelength of the ultraviolet may be suitably selected within a range of 300 to 400 nm. Irradiation with ultraviolet is to supply such energy required for cutting off Si—Si σ bonds.

Moreover, vitrification of the patterning material 202 in the above-described irradiating treatment step with ultraviolet is a function of a film thickness of the patterning material 202 and an irradiation time with ultraviolet. Accordingly, appropriate values may be selected from the film thickness of the patterning material 202 and the irradiation time with ultraviolet by evaluating the peak judgment according to FT-IR, changes in refractive index and the like for vitrifying completely the patterning material 202. According to the experiments made by the inventor(s) of the application, the whole film of the patterning material 202 can be substantially vitrified by irradiating with ultraviolet having a wavelength of 300 to 400 nm for 3 to 5 minutes in the case that a film thickness of the patterning material 202 made from polymethyl phenylsilane is around 2 μm.

(2) In the above-described second embodiment, although the superhigh pressure mercury lamp 16′ is placed in a lower position of the sample holder separate from the superhigh pressure mercury lamp 16 disposed in the upper position of the mold 200, the invention is not limited thereto as a matter of course, it may be arranged in such that a single superhigh pressure mercury lamp is movably disposed, whereby the patterning material 202 is irradiated with ultraviolet from a desired direction.

(3) The above-described second embodiment may suitably be combined with the above-described paragraphs (1) through (2).

### Modifications of the First Embodiment and Second Embodiment

The above-described first embodiment and second embodiment may be modified as shown in the following paragraphs (1) through (7).

(1) In the first embodiment and second embodiment, a series of the steps from the prebaking treatment step to the post-baking treatment step is implemented, whereby defects in a fine pattern are allowed to decrease, and heat resistance, chemical resistance, and hardness are remarkably improved. However, the invention is not limited to that described above as a matter of course, it may be arranged in such that both the prebaking treatment step and post-baking treatment step are omitted, or either of the prebaking treatment step and post-baking treatment step is omitted dependent on the use application thereof. Even in such cases, after a fine pattern is formed on the patterning material 202, when the resulting patterning material 202 is irradiated with ultraviolet to vitrify the whole of the patterning material 202 through photooxidization, and further the pattering material 202 thus treated is irradiated with oxygen plasma to oxidize the surface thereof, consequently to be rigidified, the mineralized patterning material 202 can be obtained as in the above-described first embodiment. Furthermore, after a fine pattern is formed on the patterning material 202, the resulting patterning material 202 is irradiated with ultraviolet from the side of the substrate 204 as the first irradiation with ultraviolet, whereby the patterning material 202 is vitrified through photooxidation while leaving a region in the vicinities of the boundary face between the patterning material 202 and the mold 200, further the patterning material 202 thus treated is irradiated with oxygen plasma, whereby the surface thereof is oxidized to be rigidified, thereafter, the second irradiation with ultraviolet is conducted to vitrify the region which has not yet been vitrified through photooxidation in accordance with the above-described first irradiation with ultraviolet through photooxidation, whereby the mineralized patterning material 202 can be obtained as in the above-described second embodiment.

(2) In the first embodiment and second embodiment, although polyphenyl methylsilane is used for the patterning material, the invention is not limited thereto, but it is also possible to use the following polysilanes other than polyphenyl methylsilane, for example, a material wherein Si—Si bond changes into Si—O—Si bond by irradiation with ultraviolet.

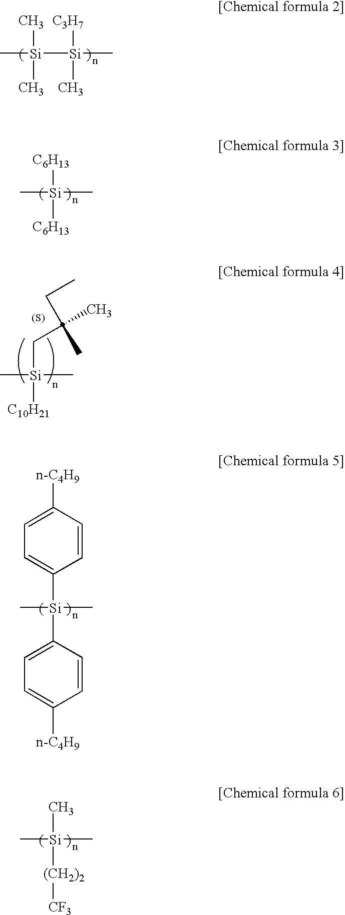

(3) In the above-described first embodiment and second embodiment, although the mold 200 is prepared from quartz glass through which ultraviolet transmits, the material for preparing the mold 200 is not limited to quartz glass, but the other materials may be used so far as ultraviolet transmits them. In the first embodiment, the mold 200 may be made from a material through which ultraviolet does not transmits in the case that the substrate 204 is made from a material such as quartz glass through which ultraviolet transmits.

(4) In the above-described first embodiment and second embodiment, although the case that a fine pattern is formed on the patterning material 202 which has been formed on the substrate 204 is described, the invention is not limited thereto, but the invention may be applied in the case that a fine pattern is formed on a variety of patterning materials in a variety of fields.

(5) In the above-described first embodiment and second embodiment, although a superhigh pressure mercury lamp is used for a light source for irradiating ultraviolet, the invention is not limited thereto, but a light source emitting ultraviolet having a wavelength of 300 to 400 nm may be used; an example thereof includes a high pressure mercury lamp, a low pressure mercury lamp, a Deep-UV lamp and the like.

(6) In the above-described first embodiment and second embodiment, although numerical values are specified in respect of temperatures, pressures, treating times, wavelengths of ultraviolet, flow rates and pressures of oxygen plasma, they are mere exemplifications as a matter of course. Accordingly, these numerical values may, of course, be suitably changed in response to a contour of a fine pattern, and materials constituting the mold 200 or the patterning material 202.

(7) The above-described first embodiment and second embodiment may suitably be combined with the modifications as described in the above paragraphs (1) through (6).

### INDUSTRIAL APPLICABILITY

The present invention may be used for fabricating a device required for durability and a high aspect ratio structure. For instance, the invention may be applied to the formation of a flow channel for an optical device, a biochip or the like in photonic crystals, and the formation of a fine pattern in the case that storage devices, molds for nanoimprinting, micro lenses, displays and the like are manufactured.

1. A method of forming a fine pattern by pressing a mold, on which a fine pattern having a fine structure with recesses and protrusions has been formed, against a patterning material to transfer the fine pattern having the fine structure with recesses and protrusions to the patterning material, comprising:
a first step for pressing the mold, on which the fine pattern having the fine structure with recesses and protrusions has been formed, against a patterning material made from polysilane;
a second step for irradiating the patterning material with ultraviolet while maintaining the condition in which the mold is pressed against the patterning material to photooxidize the patterning material;
a third step for releasing the pressing of the mold against the patterning material to draw the patterning material˜from the mold; and
a fourth step for irradiating the surface of the patterning material to which the fine pattern of the patterning material, which was drawn from the mold in the third step, has been transferred with oxygen plasma to oxidize the surface of the patterning material to which the fine pattern of the patterning material has been transferred.

2. The method of forming a fine pattern according to claim 1, comprising further:
a fifth step for heating the patterning material which was irradiated with oxygen plasma in the fourth step.

3. The method of forming a fine pattern according to claim 1, comprising further:
a step for heating the polysilane prior to applying the first step.

4. The method of forming a fine pattern according to claim 1, wherein:
the mold is made from a material through which ultraviolet transmits; and
the irradiation with ultraviolet in the second step is implemented in such that the patterning material is irradiated with ultraviolet from the side of the mold.

5. The method of forming a fine pattern according to claim 1, wherein:
the patterning material is disposed on the substrate;
the substrate is made from a material through which ultraviolet transmits; and
the irradiation with ultraviolet in the second step is implemented in such that the patterning material is irradiated with ultraviolet from the side of the substrate.

6. The method of forming a fine pattern according to claim 4, wherein:
the material through which ultraviolet transmits is quartz glass.

7. A method of forming a fine pattern by pressing a mold, on which a fine pattern having a fine structure with recesses and protrusions has been formed, against a patterning material to transfer the fine pattern having the fine structure with recesses and protrusions to the patterning material, comprising:
a first step for pressing the mold, on which the fine pattern having the fine structure with recesses and protrusions has been formed, against a patterning material made from polysilane;
a second step for irradiating the patterning material with ultraviolet while maintaining the condition in which the mold is pressed against the patterning material to photooxidize a region of the patterning material except for the boundary face region between the patterning material and the mold;
a third step for releasing the pressing of the mold against the patterning material to draw the patterning material from the mold;
a fourth step for irradiating the surface of the patterning material to which the fine pattern of the patterning material, which was drawn from the mold in the third step, has been transferred with oxygen plasma to oxidize the surface of the patterning material to which the fine pattern of the patterning material has been transferred; and
a fifth step for irradiating the patterning material with ultraviolet to photooxidize the boundary face region which has not yet been photooxidized in the second step.

8. The method of forming a fine pattern according to claim 7, comprising further:
a sixth step for heating the patterning material which was irradiated with ultraviolet in the fifth step.

9. The method of forming a fine pattern according to claim 7, comprising further:
a step for heating the polysilane prior to applying the first step.

10. The method of forming a fine pattern according to claim 7, wherein:
the patterning material is disposed on the substrate;
the substrate is made from a material through which ultraviolet transmits; and
the irradiation with ultraviolet in the second step is implemented in such that the patterning material is irradiated with ultraviolet from the side of the substrate.

11. The method of forming a fine pattern according to claim 10, wherein:
the material through which ultraviolet transmits is quartz glass.

12. The method of forming a fine pattern according to claim 1, wherein:
the patterning material is polymethyl phenylsilane (PMPS).

13. The method of forming a fine pattern according to claim 7, wherein: the patterning material is polymethyl phenylsilane (PMPS).
